(19) United States
(12) Patent Application Publication
(10) Pub. No.: US 2024/0364478 A1
(43) Pub. Date: Oct. 31, 2024

(54) POSITIONING METHOD FOR LOW POWER CONSUMPTION UEs

(71) Applicant: ZTE Corporation, Shenzhen (CN)

(72) Inventors: Cong WANG, Shenzhen (CN); Chuangxin JIANG, Shenzhen (CN); Yu PAN, Shenzhen (CN); Xuan MA, Shenzhen (CN); Focai PENG, Shenzhen (CN); Mengzhen LI, Shenzhen (CN)

(21) Appl. No.: 18/768,475

(22) Filed: Jul. 10, 2024

Related U.S. Application Data
(63) Continuation of application No. PCT/CN2023/072999, filed on Jan. 18, 2013.

(51) Int. Cl. H04L 5/00

(52) U.S. Cl. CPC H04L 5/0053

(57) ABSTRACT

This patent application discloses methods, apparatus, and systems that relate to positioning for low power consumption user equipment. In one example aspect, a method for wireless communication includes receiving, by a wireless device from a network node, configuration information; and transmitting, by a wireless device, a report comprising at least one parameter.

### CROSS-REFERENCE TO RELATED APPLICATION

This application is a continuation and claims priority to International Application No. PCT/CN2023/072999, filed on Jan. 18, 2023, the disclosure of which is hereby incorporated by reference herein in its entirety.

### TECHNICAL FIELD

This patent document is related to wireless communication.

### BACKGROUND

Mobile telecommunication technologies are moving the world toward an increasingly connected and networked society. In comparison with the existing wireless networks, next generation systems and communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

This patent document discloses techniques, among other things, related to positioning method design for low power consumption user equipment (UE).

In one example aspect, a wireless communication method is disclosed. The method includes receiving, by a wireless device from a network node, configuration information; and transmitting, by a wireless device, a report comprising at least one parameter.

In a second example aspect, a wireless communication method is disclosed. The method includes transmitting, by a network node to a wireless device, a configuration information; transmitting, by a network node to a second network node, configuration information; and receiving, from the wireless device, a report comprising one or more parameters.

In a third example aspect, a wireless communication method is disclosed. The method includes conducting an operation based on a configuration information.

In yet another example aspect, a wireless communication device comprising a process that is configured or operable to perform the above-described methods is disclosed.

In yet another example aspect, a computer readable storage medium is disclosed. The computer-readable storage medium stores code that, upon execution by a processor, causes the processor to implement an above-described method.

### BRIEF DESCRIPTION OF THE DRAWING

FIG. 1 shows a diagram of UE power consumption at state transition.

FIG. 2 shows an example of PF and PO locations.

FIG. 3 shows an example of PRS transmission.

FIG. 4 shows an example of different time locations of PF and PO (Ns=1,2,4)

FIG. 5 shows an example of PRS and PO alignment.

FIGS. 6-7 show examples of PO locations.

FIG. 8 shows an example of state transition for sub-case 1

FIG. 9 shows an example of state transition details for sub-case 2 with two micro sleep blocks.

FIG. 10 shows another example of state transition details for sub-case 2 with one micro sleep and one light sleep.

FIG. 11 shows an example of SRS group configuration.

FIG. 12 shows an example of spatial relation calculation.

FIG. 13 shows a block diagram of an example of a hardware platform that may be a part of a network device or a communication device.

FIG. 14 shows an example of network communication, including a base station (BS) and user equipment (UE) based on some implementations of the disclosed technology.

FIGS. 15-17 are flowcharts representation of methods for wireless communication in accordance with one or more embodiments of the present technology.

### DETAILED DESCRIPTION

Section headings are used in the present document to facilitate understanding and do not limit the scope of the disclosed technology to particular sections. Furthermore, certain terminology referring to 5G and Third Generation Partnership Project (3GPP) protocols is used as an illustrative example, and the disclosed techniques are also applicable to other wireless protocols. A network device in this application disclosure can be at least one of: CN (core network), gNB, LMF (Location Management Function), AMF (Access and Mobility Management Function).

In recent years, many positioning technologies have been proposed to achieve high-accuracy positioning for UE.

To reduce power consumption for LPHAP (Low Power and High Accuracy Positioning) devices, UE may enter different sleep states while not receiving or processing system/positioning signals during the positioning procedure.

Meanwhile, UE may adopt DRX (Discontinuous Reception for Paging) to reduce the power consumption. And in each DRX cycle, UE usually has to wake up and monitor PO (Paging Occasion) to receive paging messages where additional transition energy is needed.

In a general positioning process, UE has to receive/monitor PRS (Positioning Reference Signal) and/or SRS (Sounding Reference Signal), synchronization signal and PO, etc.

A network should configure PRS, SRS, synchronization signal and PO to a proper time location to reduce a UE wakeup times or duration,

From another perspective, for UL (Uplink) positioning, UE has to transmit SRS for positioning purposes. It's also power-consuming for UE to get the SRS configuration.

In this stage, UE has to establish RRC (Radio Resource Control) connection to get the updated SRS configuration when necessary (such as UE camps on a new cell). And the power consumption of RRC_CONNECTED is much greater than that of RRC_IDLE or RRC_INACTVE.

Therefore, it's crucial to reduce the SRS configuration times. This patent application discloses effective ways to lower the positioning power consumption for LPHAP devices.

### Initial Introduction:

This section discloses the background knowledge of the present patent application.

Nowadays, positioning service is typical for both indoor and outdoor users.

For indoor users, wireless-dependent positioning solutions (including TDOA, AOA, AOD, Multi-RTT, etc.) can be used to get an accurate position. In such cases, UEs have to receive and measure PRS and/or transmit SRS to get the positioning-related measurement results.

LPHAP devices, on the other hand, only perform receiving/transmitting some necessary signals to lower the power consumption and achieve longer battery life.

In current technologies, UE may enter different sleep states while not processing or receiving/transmitting signals to save power.

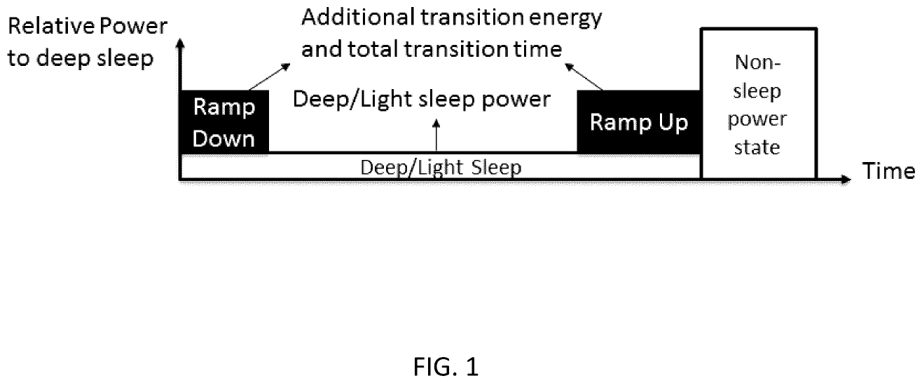

The detailed power consumption is shown in Table 1 and FIG. 1.

TABLE 1
UE power consumption during the state transition

| | Additional transition energy: | | |
|---|---|---|---|
| Sleep type | (Relative power × ms) | Total transition time | |
| Deep sleep | 450 | 20 | ms |
| Light sleep | 100 | 6 | ms |
| Micro sleep | 0 | 0 | ms* |

Immediate transition is assumed for power-saving study purposes from or to a non-sleep state

It can be seen in Table 1 that different sleep type requires additional transition energy and transition time. UE has to wake up when receiving/transmitting relevant signals. Frequent state transitions will reduce the UE battery life.

For SRS re-configuration, in the current positioning process, UE has to enter the RRC_CONNECTED state to receive updated SRS configuration when the previous SRS configuration is invalid (this phenomenon usually happens when UE moves to another cell's coverage). The power consumption of this configuration update usually accounts for a large proportion of the positioning procedure.

### Prerequisites

This section discloses some prerequisites for some embodiments disclosed below.

According to current 3GPP specifications, UE may use Discontinuous Reception (DRX) to reduce power consumption. From gNB perspective, a DRX cycle usually include one or multiple PFs (Paging Frame) concerning different UE, the SFN (System Frame Number) of PF for different UE_ID is determined by

$$( SFN + PF\_offset ) mod T = ( T div N ) * ( UE\_ID mod N ) ,$$

where N refers to the number of PF per DRX cycle, and PF_offset is the offset of each PF. These two parameters are configured in DownlinkConfigCommonSIB. T is the DRX cycle. A PF may contain multiple POs for different UE. The index (i_s) of PO for different UE_ID is determined by:

$$i\_s = floor ( UE\_ID / N ) mod Ns$$

where Ns is the number of POs per PF, which is configured in DownlinkConfigCommonSIB.

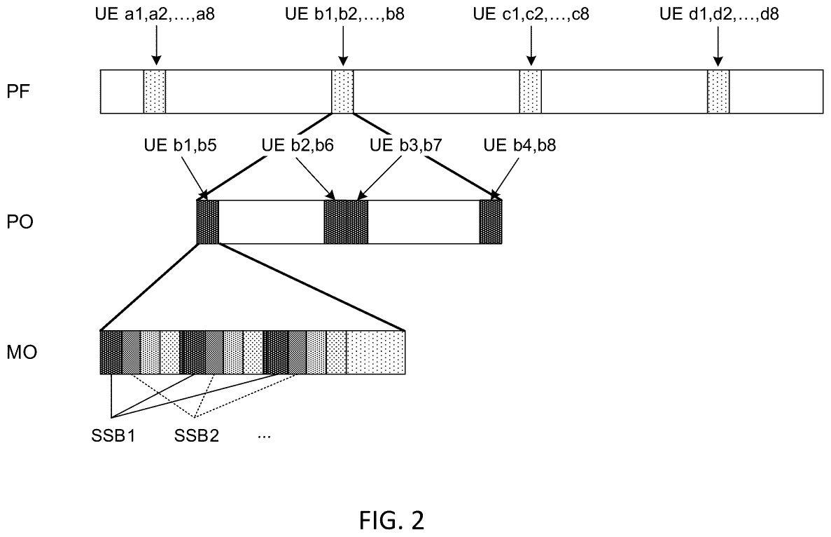

FIG. 2 discloses an example of the PF and PO locations. A PO may include multiple PDCCH MO (Monitoring Occasions), MOs are determined according to the paging search space and the configuration of SSB.

### Embodiment 1

This section discloses, among other things, examples of LPHAP device type indication, which is one way of PO configuration.

For LPHAP devices, gNB can configure the DRX parameters to align PO with PRS for UE to minimize the time gap between PRS and PO, further reduce the wakeup duration time, and finally improve the UE battery life.

In this procedure, UE can report the wireless device capability indication to the network node, such as Access and Mobility Management Function (AMF) during the registration process, and the report may contain the following IEs:
UE_ID
wireless device indicator
wireless device capability indicator

Then AMF can inform LMF (Location Management Function) the UE_ID of this LPHAP device, and LMF further informs the NG-RAN node there is n special UE camps on the current cell during the positioning process. The wireless device capability indication may include, but not limited to, the following IEs:
UE_ID
wireless device indicator
wireless device capability indicator

For NG-RAN-initiated Paging, NG-RAN node may further align the PO with PRS configuration. A gNB may configure the DRX parameters to minimize the gap between PO and PRS for different UE.

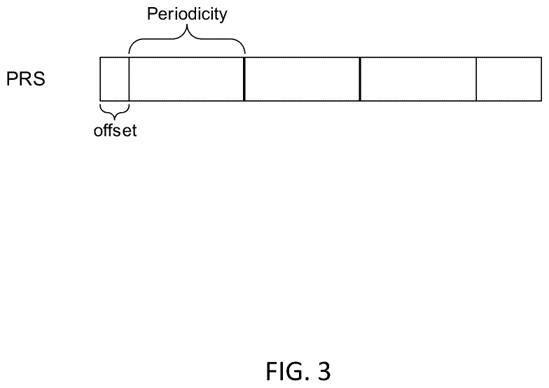

Since the PRS configuration is non-UE specific, LMF or gNB cannot configure various PRS for different UE. The PRS periodicity and offset is configured by IE NR-DL-PRS-Periodicity-and-ResourceSetSlotOffset. For a given PRS resource configuration, the PRS transmission details is shown in FIG. 3

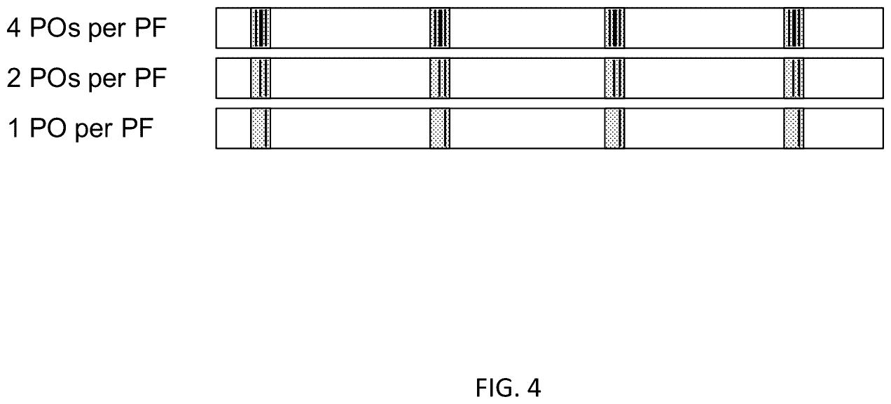

For DRX configuration, a PF may contain multiple (Ns=1,2,4) POs; example for different time locations of PF and PO is shown in FIG. 4.

For the cases when Ns=2 or 4, POs are not evenly distributed on the timeline (from gNB side), but for UE power-saving purposes, each UE should receive a PRS together with a PO.

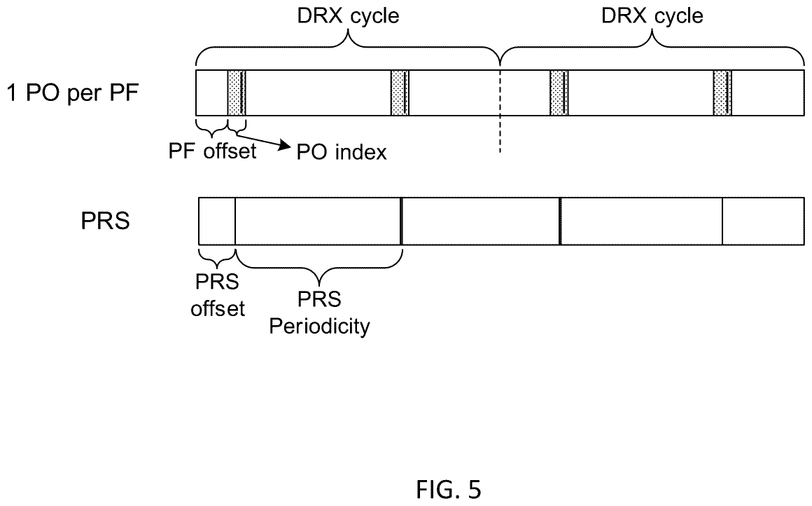

Therefore, this embodiment suggests gNB configure 1 PO per PF (Ns=1), set DRX cycle=T_{PRS}*N to align with the PRS configuration, and set PF_offset+PO index=PRS_offset±1 to minimize the gap between PRS and PO, where T_{PRS} is the periodicity of PRS. An example of this configuration is as shown in FIG. 5. For the cases there are multiple POs in a PF (Ns=2 or 4), network node/UE should configure/report different PO offsets (detailed PO offsets configuration can be found in embodiment 2 and 3).

In this way, the time locations of PRS and PO are in adjacent slots, the wakeup time of the LPHAP device can be minimized, further reducing the power consumption.

For eDRX (extended DRX), PO will only be transmitted in Paging Time Window (PTW). PFs are not evenly distributed on the timeline. The most power-saving configuration is set 1 PO per PF (Ns=1), 1 PF per eDRX cycle (N=1), eDRX cycle=T_{PR}S to align with the PRS configuration, and set PF_offset+PO index=PRS_offset±1. For the cases there are multiple POs in a PF (Ns=2 or 4), network node/UE should configure/report different PO offsets (detailed PO offsets configuration can be found in embodiment 2 and 3).

Alternatively, for CN-initiated Paging, CN can configure the (e)DRX parameters in the same way.

Since N and Ns in the PF/PO determination formula are not UE specific, as long as a cell has an LPHAP device, all UEs in the current cell will be configured with power-saving DRX settings. This embodiment is more applicable to cells with more LPHAP devices when configuring Ns=1.

### Embodiment 2

This section discloses, among other things, examples of PO offset indication through CN configuring, which is a way of PO configuration.

A network can configure different PO offset ranges from 0 to X (X can be determined with different DRX or PRS configurations) for UE in the RRCRelease signal. The PO offset information may include, but not limited to, the following IEs:
UE_ID
PO offset

The PO offset determination procedure can be divided into different cases:

Case 1: UE only receives PRS from one TRP (Transmission-Reception Point).

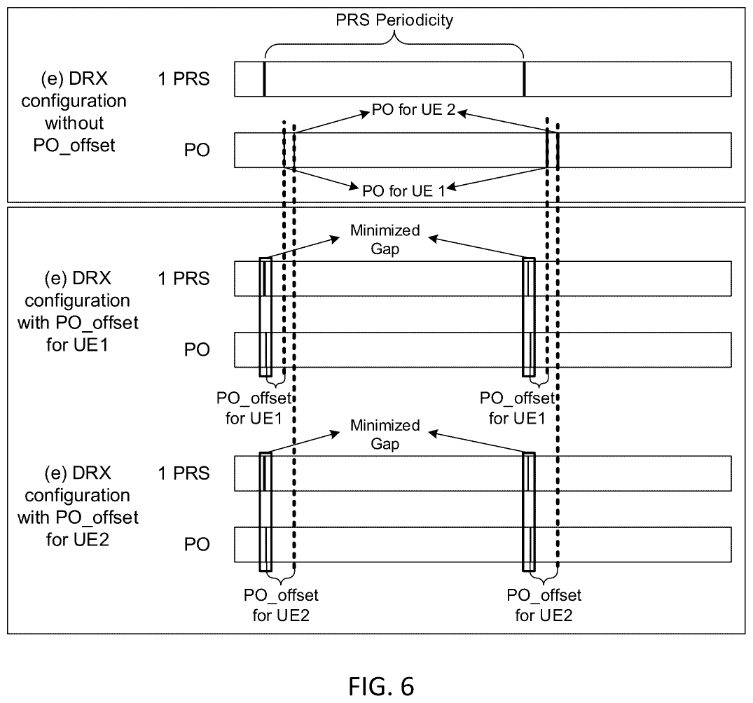

In this case, as shown in FIG. 6, CN only need to add different PO Offsets for different UEs while minimizing the gap between PRS and PO for UE, as shown in FIG. 6, the time gap between PRS and PO can be minimized.

Case 2: UE receives PRS from two or more TRPs.

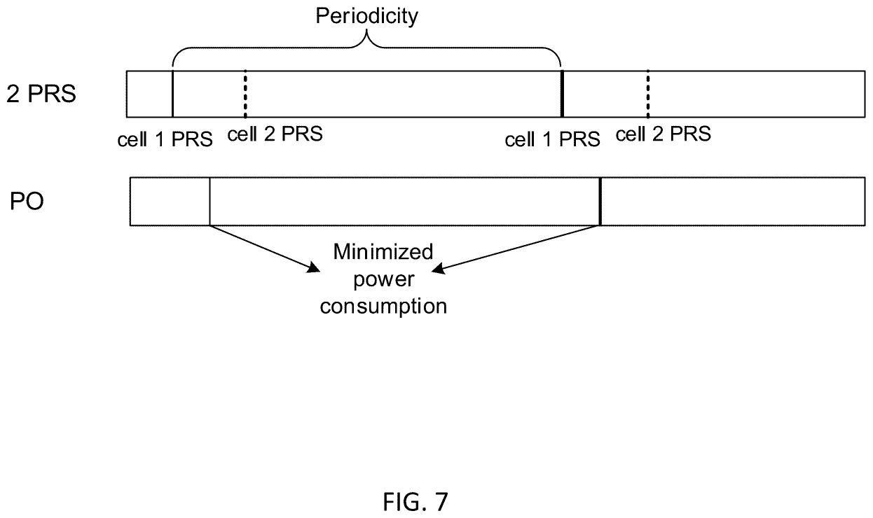

In this case, the offset of PO should consider the time gap between PRS from different TRPs while minimizing the UE's power consumption, as shown in FIG. 7.

The specific PO time location could be calculated based on the gap between two adjacent PRS.

As defined in Table 1, which is also illustrated in 3GPP standard 38.840, UE could enter light sleep when the time gap between two signals is greater than 6 ms and enter deep sleep when the time gap is greater than 20 ms.

Based on the power consumption model, PO's time location that minimizes the power consumption can be determined.

Based on the desired PO time location, a proper PO_offset could be determined. Take PRS from 2 TRPs as an example, the proper PO offset can be calculated as follows (denote D_{PRS} as the time gap between two adjacent PRS, and D_{PO} refers to the PO duration):

Sub-case 1: D_{PRS}∈[0,6+D_{PO}) ms.

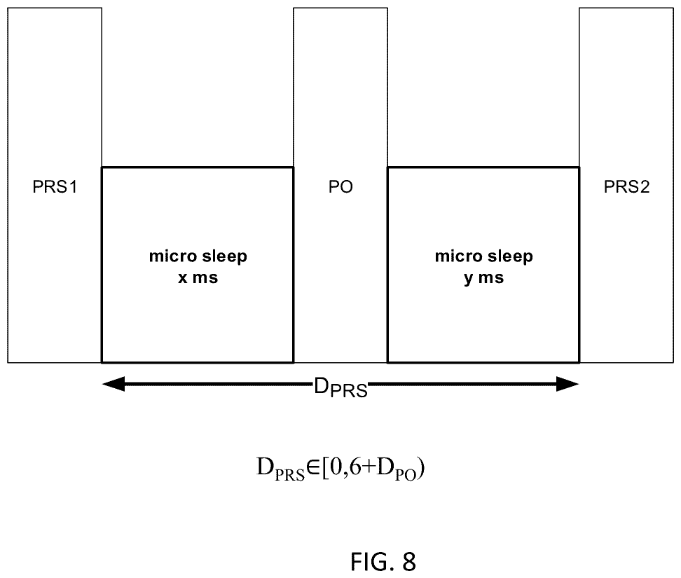

In this sub-case, UE cannot enter light sleep because the time gap between PO and PRS is less than the total transition time of light sleep (6 ms). The state transition in this case can be as shown in FIG. 8:

In FIG. 8, x,y<6 refers to the duration of micro sleep for different time slots, and x+y=D_{PRS}−D_{PO}, with these limitations, we can calculate the PO location that minimizes the power consumption of PRS and PO receiving procedure.

Sub-case 2: D_{PRS}∈[6+D_{PO},12+D_{PO}) ms.

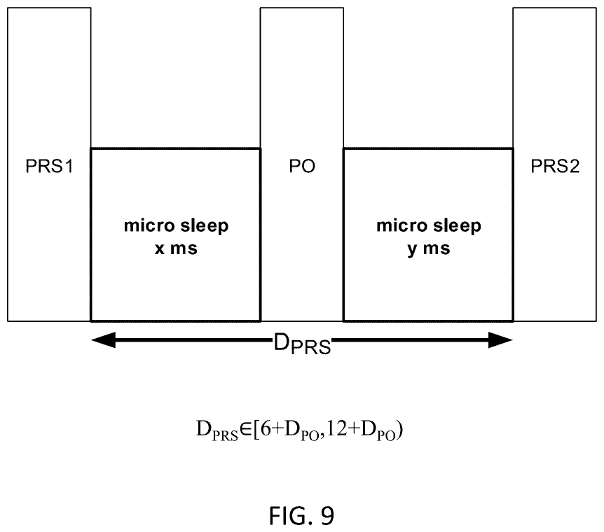

In this sub-case, UE may enter micro sleep state for twice or one micro sleep and one light sleep. State transition detail with two micro sleep states is shown in FIG. 9.

As shown in FIG. 9, x,y<6, and x+y=D_{PRS}−D_{PO}.

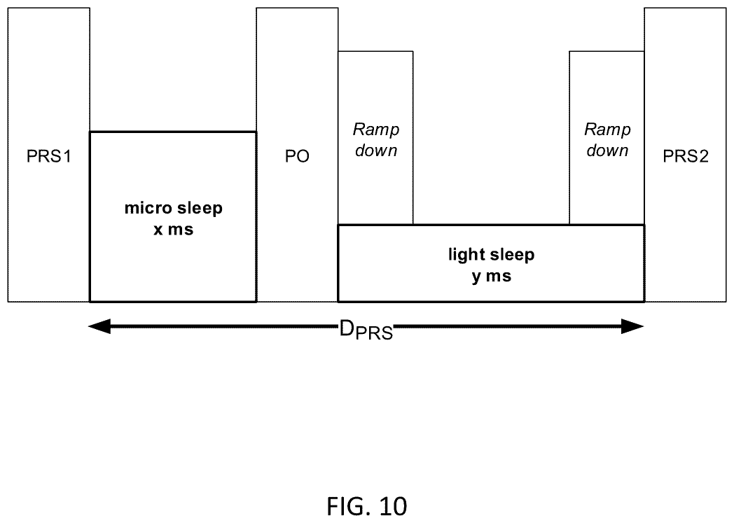

State transition detail with one micro sleep and one light sleep is shown in FIG. 10.

As shown in FIG. 10, x<6 refers to the duration of micro sleep, 6<y<D_{PRS}−PO refers to the duration of light sleep, and x+y=D_{PRS}−D_{PO}. With these limitations, the PO location that minimizes power consumption can be determined.

For other cases, such as D_{PRS}≥12+D_{PO}, the power consumption evaluation can also be calculated similarly. For PRS from multiple TRPs, the best PO location that minimizes the power consumption can be calculated based on the power consumption model.

### Embodiment 3

This section discloses, among other things, examples of PO offset indication through UE reporting, which is another way of PO configuration.

Before reporting the PO offset, UE may receive PRS and PO at any time. UE have to wake up once a PRS or PO reaches its receiving antenna. But in general, the transmission of PRS and PO is periodical. UE can try to monitor the location of different PO close to the PRS, to reduce the number of wakeups or wakeup duration.

UE can report PO offset ranges from 0 to X (X can be determined with different DRX/eDRX or PRS configuration) to LMF in LPP (LTE Positioning Protocol) message. In LPP messages, there are three message types send from UE to LMF, i.e., Provide Capabilities, Request Assistance Data and Request Location Information. The PO offset information may include, but is not limited to, the following IEs:
UE_ID
PO offset

For CN-initiated Paging, PO offset can be used to monitor the PO location. LMF can further inform the desired PO offset of different UEs to gNB during the positioning process in the LPP message.

Alternatively, UE can report PO offset ranges from 0 to X (X can be determined with different DRX/eDRX or PRS configuration) to the network in UEAssistanceInformation. In UEAssistanceInformation, an IE indicating DRX-Preference is included. This IE supports the report for UE expected DRX parameters setting. UE expected PO offset information may also be included in this IE.

Alternatively, for NG-RAN-initiated Paging, gNB can configure the desired PO offset for different UE to align with PRS. The PO offset information may include, but not limited to, the following IEs:
UE_ID
PO offset

### Embodiment 4

This section discloses, among other things, examples of SRS group configuration.

In the current UL positioning procedure, UE has to establish RRC connection when receiving SRS configuration or SRS configuration update, which is power-consuming for UE. This embodiment tries to reduce the SRS configuration times by configuring SRS parameters in a cell group, further improving the UE battery life.

In general, UE will get a new SRS configuration when it moves to a new cell or the previous SRS configuration is invalid. But in fact, most parameters in SRS configuration can be reused in different cells, except spatial relation and TA (Timing Advance). To get the spatial relation of different cells for SRS, LMF can define the SRS configuration group, such as SRSConfigGroup, for different gNB, i.e., provide SRS configuration suggestions concerning cell group in Requested SRS Transmission Characteristics. In return, NG-RAN node may also report the SRS configuration group, such as SRSConfigGroup, to the LMF. Further, a new parameter configuration, such as SRSConfigGroup, can be added to IE SRS-config. The SRS configuration group may contain, but not limited to, one or more of the following IEs:
An IE containing the Phycell ID within the group
An IE containing the location of gNB within the group
An IE containing the group ID

The spatial relation determination across different cells can be calculated with the help of SRS configuration group.

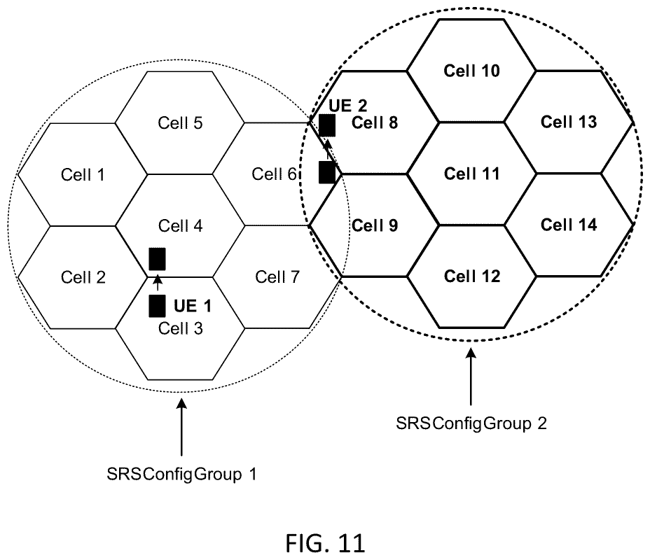

For example, as shown in FIG. 11, UE 1 moves from cell 3 to cell 4, we have the following known parameters:

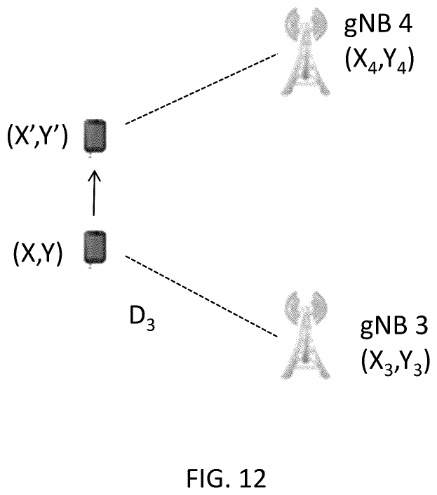

Suppose the coordination of gNBs in cells 3 and 4 are (x₃,y₃) and (x₄,y₄) (UE can get these coordinates from SRS configuration group). The spatial relation on cell 3 is configured, denoted as α(UE can get this directly from spatialRelationInfo), let D₃ denote the estimated distance between UE and gNB 3 (D₃ can be estimated based on the previous TA), based on the above parameters, UE can calculate the estimated coordination (X, Y) based on the following equations (as shown in FIG. 12):

$${( {X}_{3} - X )}^{2} + {( {Y}_{3} - Y )}^{2} = {D}_{3}^{2}$$

$$arctan \frac{{Y}_{3} - Y}{{X}_{3} - X} = α$$

The estimated coordination (X′,Y′) after movement can be evaluated based on the movement information and estimated coordination (X, Y). Based on the coordination of gNB 4 as included in SRS configuration group information, the spatial relation on cell 4 (SRS transmitting direction α′) can be calculated as follows:

$${α}^{′} = arctan \frac{{Y}_{4} - {Y}^{′}}{{X}_{4} - {X}^{′}}$$

The TA in a new cell (refers to cell 4 in FIG. 11) can be determined using one of the following options:
Calculate TA based on the estimated distance between UE and the gNB in a new cell.
Reuse the TA from the old cell.

Note that the SRS transmitting direction and TA can be updated after receiving SSB/PRS/CSI-RS from gNB 4.

A group of nodes in the same SRS configuration group share the same SRS configuration information. For example, as shown in FIG. 11, UE 1 moves from cell 3 to cell 4 (in the same group), and the SRS configuration will not be updated. UE 2 moves from cell 6 to cell 8 (in a different SRS configuration group). It has to get the updated SRS configuration.

### Embodiment 5

This section discloses, among other things, using TRS to replace SSB for improving the flexibility and efficiency of positioning.

In the current positioning procedure, the synchronization of different nodes mainly relies on the reception of SSB, but the time location of SSB is usually subject to the configured SSB burst. UE has to wake up to receive SSB based on the configured parameter settings, which may lead to greater power consumption.

An alternative option is taking CSI-RS (Channel State Information-Reference Signal) for tracking, i.e., TRS, to perform the synchronization function.

The configuration of TRS is more flexible than that of SSB. The index of TRS within a slot can be located in any OFDM symbol. The periodicity and OFDM symbol index can be adjusted based on the PRS/PO configuration, further configure TRS close to the PRS/PO. TRS may support more periodicity options to align better with PRS/PO, further minimize the gap between TRS and other signals, and finally reduce the wakeup duration or the times of wakeups.

### Embodiment 6

This section discloses, among other things, QCL source update configuration.

In the current positioning procedure, dl-PRS-QCL-Info includes SSB and dl-PRS. The demodulation of PRS only relies on SSB or other PRS. The QCL source of DL PRS could also include the following signals:
CSI-RS
Paging Occasion

As described in Embodiment 5, realizing synchronization function with TRS instead of SSB is beneficial to reduce the power consumption, and CSI-RS is thereupon added to the QCL source of PRS. From another perspective, gNB will transmit PO when Paging is initiated, PO can also be added to the source of PRS. In this way, UE may demodulate PRS while get the QCL relation.

The monitoring occasions of PO are determined according to the SSB burst. In some cases, for power-saving purpose, UE can skip receiving SSB. The QCL source of Paging could also include the following signals:
PRS
CSI-RS

### Embodiment 7

This section discloses, among other things, QoS report configuration design.

LPHAP UE may have different QoS requirements in different positioning applications or scenarios. This embodiment tries to report UE's QoS for positioning, detailed QoS may contain, but not limited to, one or more of the following IEs:
An IE containing the horizontal accuracy requirement
An IE containing the vertical accuracy requirement
An IE containing the response time requirement

The IEs in NRPPA are non UE specific, the QoS indication of different UE should be reported to AMF. The AMF initiates the procedure by sending the DOWNLINK UE ASSOCIATED NRPPA TRANSPORT message to the NG-RAN node.

gNB can further configure SRS based on the QoS requirement, and optionally, gNB can define SRS priority for UE with different QoS requirements.

Note that the QoS requirement may also be applicable to other device types.

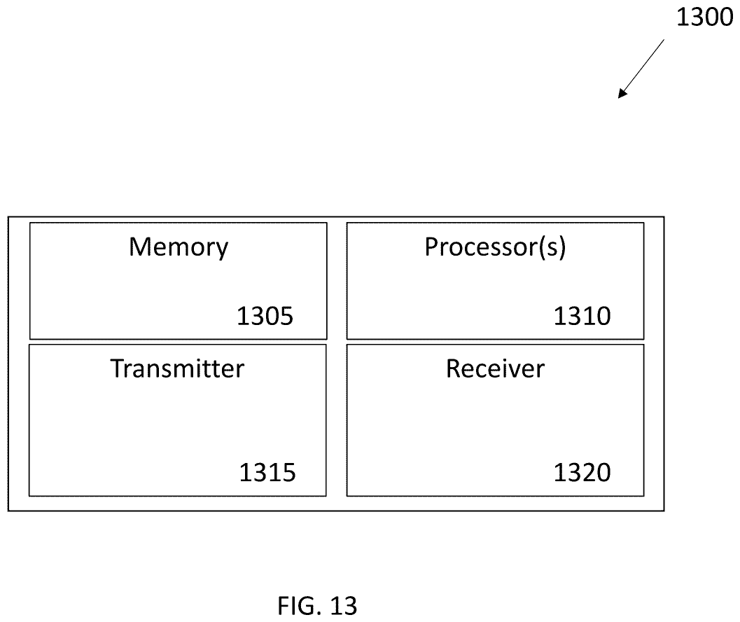

FIG. 13 shows an exemplary block diagram of a hardware platform 1300 that may be a part of a network device (e.g., base station) or a wireless device (e.g., a user equipment (UE)). The hardware platform 1300 includes at least one processor 1310 and a memory 1305 having instructions stored thereupon. The instructions upon execution by the processor 1310 configure the hardware platform 1300 to perform the operations described in FIG. 13 and in the various embodiments described in this patent application document. The transmitter 1315 transmits or sends information or data to another device. For example, a network device transmitter can send a message to user equipment. The receiver 1320 receives information or data transmitted or sent by another device. For example, user equipment can receive a message from a network device.

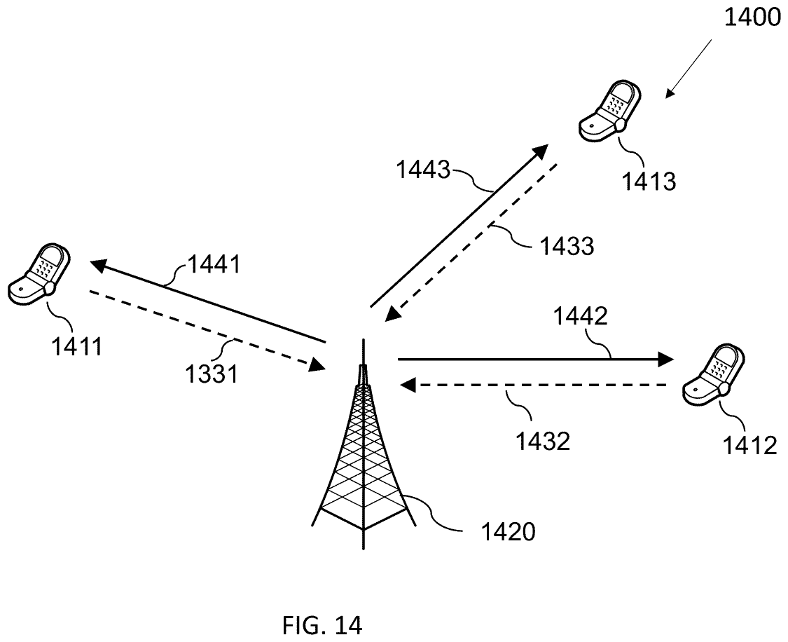

The implementations as discussed above will apply to a network communication. FIG. 14 shows an example of a communication system (e.g., a 6G or NR cellular network) that includes a base station 1420 and one or more user equipment (UE) 1411, 1412 and 1413. In some embodiments, the UEs access the BS (e.g., the network) using a communication link to the network (sometimes called uplink direction, as depicted by dashed arrows 1431, 1432, 1433), which then enables subsequent communication (e.g., shown in the direction from the network to the UEs, sometimes called downlink direction, shown by arrows 1441, 1442, 1443) from the BS to the UEs. In some embodiments, the BS send information to the UEs (sometimes called downlink direction, as depicted by arrows 1441, 1442, 1443), which then enables subsequent communication (e.g., shown in the direction from the UEs to the BS, sometimes called uplink direction, shown by dashed arrows 1431, 1432, 1433) from the UEs to the BS. The UE may be, for example, a smartphone, a tablet, a mobile computer, a machine to machine (M2M) device, an Internet of Things (IoT) device, and so on.

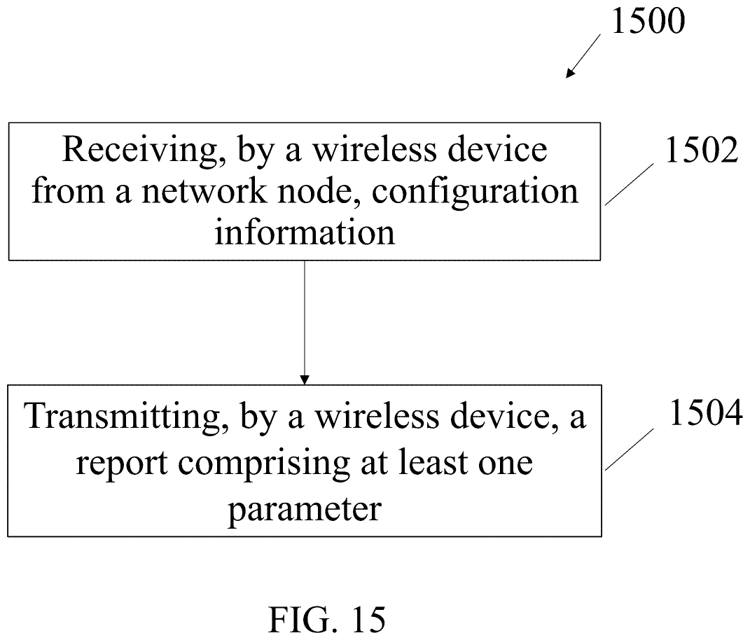

Various preferred embodiments and additional features of the above-described method of FIGS. 15-17 are as follows. Further examples are described with reference to embodiments 1 to 7.

In one example aspect, as depicted in FIG. 15, a wireless communication method is disclosed. The method includes receiving (1502), by a wireless device from a network node, configuration information; and transmitting (1504), by a wireless device, a report comprising at least one parameter.

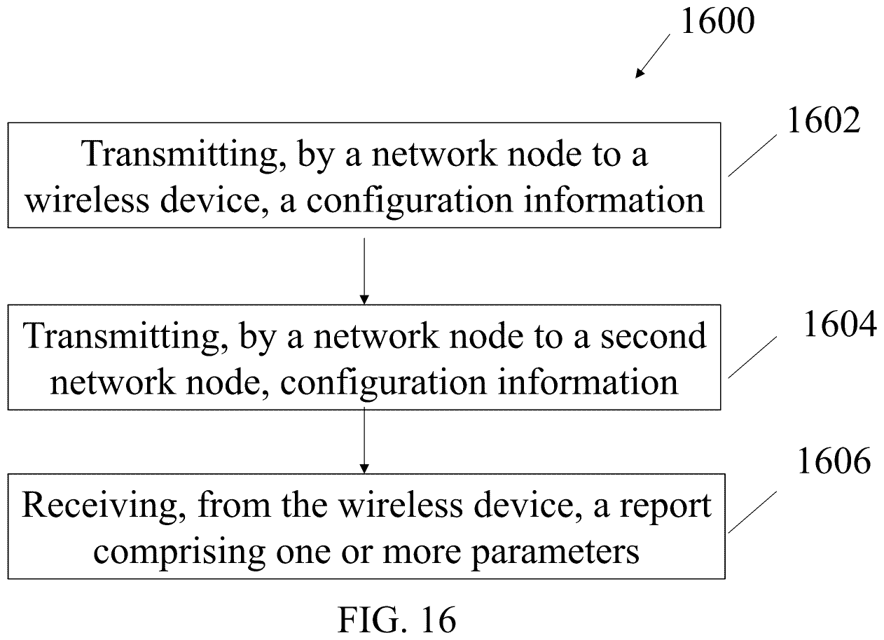

In a second example aspect, as depicted in FIG. 16, a wireless communication method is disclosed. The method includes transmitting (1602), by a network node to a wireless device, a configuration information; transmitting (1604), by a network node to a second network node, configuration information; and receiving (1606), from the wireless device, a report comprising one or more parameters.

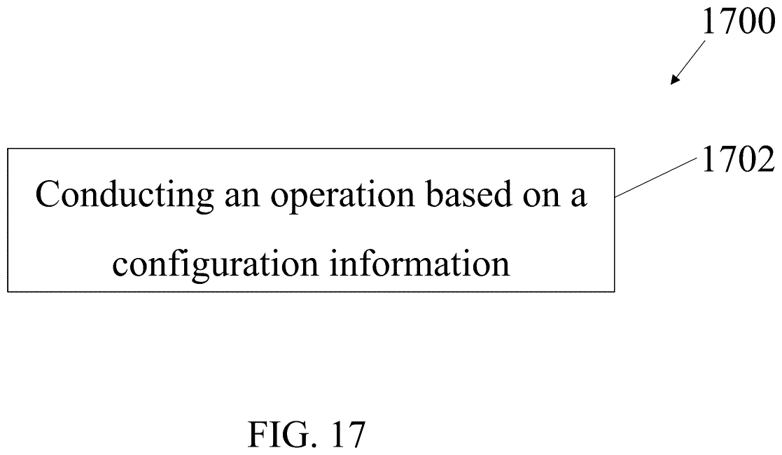

In a third example aspect, as depicted in FIG. 17, a wireless communication method is disclosed. The method includes conducting (1702) an operation based on a configuration information. The method may be implemented by a wireless device or a network device.

In some embodiments, the parameters comprise a positioning related indication of the wireless device.

In some embodiments, the configuration information comprises discontinuous reception (DRX) parameters.

In some embodiments, DRX parameters is determined by a positioning related indication.

In some embodiments, the positioning related indication of the wireless device comprises: 1) a user equipment identity (UE_ID) 2) a wireless device indication or 3) a wireless device capability indication.

In some embodiments, the wireless device indication comprises: 1) 1 bit binary indicator for a device type; or 2) enumerated choices that include indications for the device type.

In some embodiments, the device type comprises Low Power and High Accuracy Positioning (LPHAP) device.

In some embodiments, the wireless device capability indication comprises: 1) DRX configuration adaptation capability; or 2) PRS configuration adaptation capability; or 3) extended DRX configuration adaptation capability.

In some embodiments, the above disclosed further comprising receiving, by the wireless device from a second network device, the configuration information.

In some embodiments, the configuration information is determined by a positioning related information.

In some embodiments, the positioning related information comprises PRS reception or configuration.

In some embodiments, the configuration information comprises a first signaling location configuration when a second signaling is configured.

In some embodiments, a first signaling is a PO, wherein the second signaling is a Positioning Reference Signal (PRS).

In some embodiments, the configuration information comprises a plurality of offsets.

In some embodiments, the offsets comprise PO offset configuration.

In some embodiments, each PO offset range is between 0 and a pre-determined or configured value.

In some embodiments, the pre-determined or configured value is based on at least, one of 1) DRX or 2) PRS configuration.

In some embodiments, the pre-determined or configured value can be used to determine a Paging Occasion (PO) location.

In some embodiments, the PO location is determined by PO index (i_s), i_s could be determined by i_s=floor (UE_ID/N) mod Ns+PO_offset_{UE_ID(Ni)}, wherein PO_offset_{UE_ID(Ni)} is a reported PO offset value for UE in a Ni-th (Ni<=Ns) PO in a paging frame (PF).

In some embodiments, the configuration information comprises positioning related information.

In some embodiments, the positioning related information comprises Sound Reference Signal (SRS) configuration to be used in a positioning procedure.

In some embodiments, the SRS configuration comprises a Phycell group configuration.

In some embodiments, the Phycell group configuration comprises at least one of 1) an Information Element containing a Phycell ID within the group, 2) an IE containing a location of a network device within the group or 3) an IE containing an identity of the group.

In some embodiments, the operation comprises an indicative of receiving a reference signal.

In some embodiments, the reference signal comprises CSI-RS (Channel State Information-Reference Signal) for tracking (TRS).

In some embodiments, the operation comprises using a first parameter to replace a second parameter.

In some embodiments, the first parameter is capable of being transmitted in more time locations than the second parameter is within a transmission frame.

In some embodiments, the first parameter is CSI-RS (Channel State Information-Reference Signal) for tracking (TRS).

In some embodiments, the second parameter is a synchronization signal/physical broadcast channel (PBCH) block (SSB).

In some embodiments, the operation comprises a processing of a first signal based on the configuration information.

In some embodiments, in the configure information comprises a positioning related configuration of a first signal comprising of a second signal.

In some embodiments, the configuration information comprises a QuasiCo-Location (QCL) configuration.

In some embodiments, the first signal is a Positioning Reference Signal (PRS), the second signal is at least, one of: 1) channel state information reference signal (CSI-RS), 2) Paging Occasion (PO).

In some embodiments, the processing is related to PRS channel characteristic information acquisition based on a QuasiCo-Location (QCL) configuration.

In some embodiments, the first signal can also be a PO, the second signal can also be at least, one of: 1) CSI-RS, 2) PRS.

In some embodiments, the processing is related to PO channel characteristic information acquisition based on a QCL configuration.

In some embodiments, the parameters comprise an indicative of a positioning requirement.

In some embodiments, the above second method further comprising: receiving, by a second network device from a network device, an indicative of a positioning requirement.

In some embodiments, configuration information is based on a positioning requirement.

In some embodiments, the positioning requirement comprises quality of service (QoS) in different positioning scenarios.

In some embodiments, the indicative comprises but not limited to, one or more of: 1) an Information Element (IE) containing a horizontal accuracy requirement, 2) an IE containing a vertical accuracy requirement, or 3) an IE containing a response time requirement.

It will be appreciated that the present document discloses methods and apparatus related to positioning configuration for low power consumption UEs in a wireless communication system. In a current system design, a UE must wake up when receiving/transmitting relevant signals, reducing the UE battery life. This patent application aims to solve this problem by proposing multiple positioning configuration schemes for UE, especially for low power consumption UE in different transmission scenarios. The proposed methods are beneficial at least for helping to save the battery consumption for the UEs.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method of wireless communication, comprising:
transmitting, by a network node to a wireless device, a configuration information including positioning related information that comprises sound reference signal (SRS) configuration to be used in a positioning procedure;
transmitting, by the network node to a second network node, the SRS configuration to be used in the positioning procedure; and
receiving, from the wireless device, in response to the SRS configuration to be used in the positioning procedure, a report comprising one or more parameters.

2. The method of claim 1, wherein the SRS configuration comprises a Phycell group configuration.

3. The method of claim 2, wherein the Phycell group configuration comprises an Information Element containing a Phycell ID within a group.

4. A wireless communication apparatus comprising a processor and a memory including instructions that cause the processor to:
transmit, to a wireless device, a configuration information including positioning related information that comprises sound reference signal (SRS) configuration to be used in a positioning procedure;
transmit, to a second network node, the SRS configuration to be used in the positioning procedure; and
receive, from the wireless device, in response to the SRS configuration to be used in the positioning procedure, a report comprising one or more parameters.

5. The wireless communication apparatus of claim 4, wherein the SRS configuration comprises a Phycell group configuration.

6. The wireless communication apparatus of claim 5, wherein the Phycell group configuration comprises an Information Element containing a Phycell ID within a group.

7. A computer-readable program medium having instructions stored thereon, the instructions, when executed by a processor, causing the processor to:
transmit, to a wireless device, a configuration information including positioning related information that comprises sound reference signal (SRS) configuration to be used in a positioning procedure;
transmit, to a second network node, the SRS configuration to be used in the positioning procedure; and
receive, from the wireless device, in response to the SRS configuration to be used in the positioning procedure, a report comprising one or more parameters.

8. The computer-readable program medium of claim 7, wherein the SRS configuration comprises a Phycell group configuration.

9. The computer-readable program medium of claim 8, wherein the Phycell group configuration comprises an Information Element containing a Phycell ID within a group.
